(19) United States
(12) Patent Application Publication
(10) Pub. No.: US 2022/0309233 A1
(43) Pub. Date: Sep. 29, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Ryo AKAMINE, Kanagawa (JP)

(73) Assignee: FUJIFILM BUSINESS INNOVATION CORP., Tokyo (JP)

(21) Appl. No.: 17/411,730

(22) Filed: Aug. 25, 2021

(30) Foreign Application Priority Data
Mar. 24, 2021 (JP) 2021-049843

(51) Int. Cl. G06F 40/174; G06K 9/00; G06K 9/62

(52) U.S. Cl. CPC G06F 40/174; G06K 9/00442; G06K 9/6215

(57) ABSTRACT

An information processing apparatus includes: a processor configured to: acquire a history of character strings assigned to document data by a user; specify a pattern in the character strings assigned to the document data using the history of the character strings; and generate a candidate character string to be assigned to document data of interest according to a character string included in the document data of interest and the specified pattern.

### CROSS-REFERENCE TO RELATED APPLICATIONS

This application is based on and claims priority under 35 USC 119 from Japanese Patent Application No. 2021-049843 filed Mar. 24, 2021.

### BACKGROUND

### (i) Technical Field

The present disclosure relates to an information processing apparatus and a non-transitory computer readable medium.

### (ii) Related Art

For example, JP-A-2016-99741 discloses a method of acquiring a document whose attributes indicating types of desired information can be extracted as an analysis target, determining whether the attributes are valid, selecting an attribute to be used for analysis from attribute candidates determined to be valid, and extracting an expression belonging to the selected attribute from the document as an attribute expression.

### SUMMARY

Aspects of non-limiting embodiments of the present disclosure relate to generating a candidate character string to be assigned to a new document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to: acquire a history of character strings assigned to document data by a user; specify a pattern in the character strings assigned to the document data using the history of the character strings; and generate a candidate character string to be assigned to document data of interest according to a character string included in the document data of interest and the specified pattern.

### BRIEF DESCRIPTION OF THE DRAWINGS

Exemplary embodiment(s) of the present disclosure will be described in detail based on the following figures, wherein:

FIG. 1 is a block diagram illustrating a configuration of an information processing system according to an exemplary embodiment of the disclosure;

FIG. 2 is a block diagram illustrating a hardware configuration of a document data storage apparatus according to the exemplary embodiment;

FIG. 3 is a block diagram illustrating a hardware configuration of an information processing apparatus according to the exemplary embodiment;

FIG. 4 is a diagram illustrating data stored in the document data storage apparatus;

FIG. 5 is a diagram illustrating data stored in the document data storage apparatus;

FIG. 6 is a block diagram illustrating a functional configuration of the information processing apparatus according to the exemplary embodiment;

FIG. 7 is a flowchart of an operation of the information processing apparatus according to the exemplary embodiment; and

FIG. 8 is a diagram showing an example of a screen displayed on a display device of a UI unit of the information processing apparatus according to the exemplary embodiment.

### DETAILED DESCRIPTION

### [1] Configuration

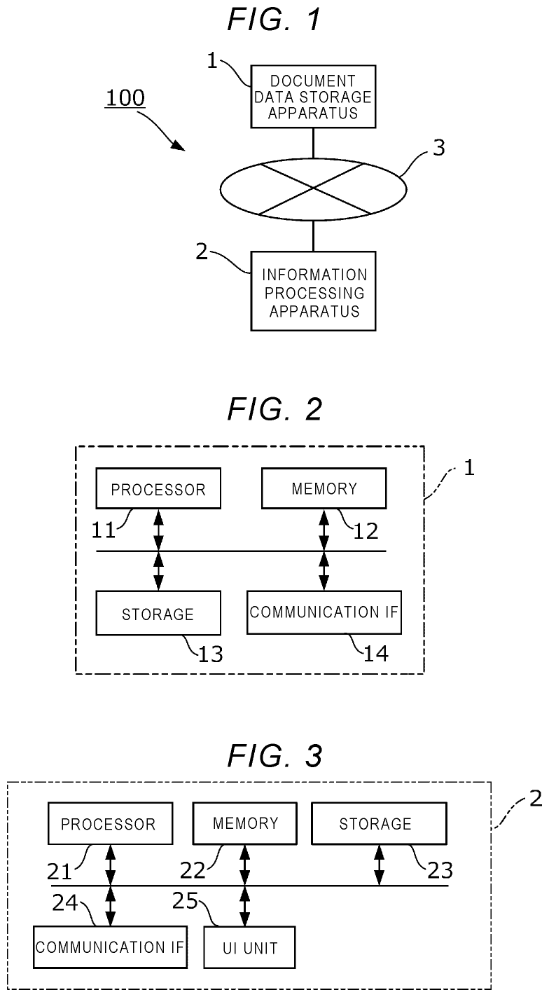

FIG. 1 is a block diagram illustrating a configuration of an information processing system 100 according to an exemplary embodiment. The information processing system 100 includes a document data storage apparatus 1 and an information processing apparatus 2. The document data storage apparatus 1 and the information processing apparatus 2 are both implemented by computers, and are connected to each other via a communication line 3 including a wireless or wired line.

FIG. 2 is a diagram showing a hardware configuration of the document data storage apparatus 1. A processor 11 is a processor that controls other elements of the document data storage apparatus 1. The memory 12 is a storage device that functions as a work area for the processor 11 to execute a program, and includes, for example, a random access memory (RAM). A storage 13 is a storage device that stores various programs and data, and includes, for example, a solid state drive (SSD) or a hard disk drive (HDD). The processor 11 executes a program stored in the memory 12 or the storage 13 to implement various functions on the document data storage apparatus 1. A communication interface (IF) 14 communicates with other apparatuses via the communication line 3 in accordance with a predetermined wireless or wired communication standard.

FIG. 3 is a diagram illustrating a hardware configuration of the information processing apparatus 2. A processor 21 is a processor that controls other elements of the information processing apparatus 2. A memory 22 is a storage device that functions as a work area for the processor 21 to execute a program, and includes, for example, a RAM. A storage 23 is a storage device that stores various programs and data, and includes, for example, an SSD or an HDD. The processor 21 executes a program stored in the memory 22 or the storage 23 to implement various functions on the information processing apparatus 2. A communication IF 24 communicates with other apparatuses in accordance with a predetermined wireless or wired communication standard. A user interface (UI) unit 25 includes, for example, a touch screen and various keys, and is operated by a user.

In the information processing system 100, the user may operate the information processing apparatus 2 to create new document data and store the new document data in the document data storage apparatus 1, or browse various document data stored in the document data storage apparatus 1. To the document data stored in the document data storage apparatus 1, the user may assign any character string as information called, for example, a tag or metadata. Such a character string is referred to as an “assigned character string”. The assigned character string is used, for example, for searching, extracting, and rearranging document data stored in the document data storage apparatus 1.

In general, the character string assigned to document data in this manner is fixed information that has been determined in advance with respect to the document data. Examples of a character string indicating a type of a document include “invoice”, “purchase order”, “contract”, and the like, and examples of a character string indicating a phase (described later) corresponding to a document include “receive order”, “construction”, “repair”, and the like. One character string is selected from a predetermined group of character strings, and is assigned to the document data. To the contrary, in the present exemplary embodiment, a character string that the user can freely choose is assigned to the document data. However, in a case where each user freely assigns character strings having no pattern to document data as he/she wants, convenience may be impaired at the time of using the search, the extraction, the rearrangement, and the like as described above, which may make assigning of the character string meaningless. For example, when an assignment rule of a character string considered by a user A and an assignment rule of a character string considered by a user B are greatly different from each other, it may be difficult for the user B to appropriately search for document data using a character string assigned to the document data by the user A. Therefore, an object of the present exemplary embodiment is to suggest to each user a character string to be assigned based on a certain pattern while maintaining a degree of freedom when each user assigns a character string to document data.

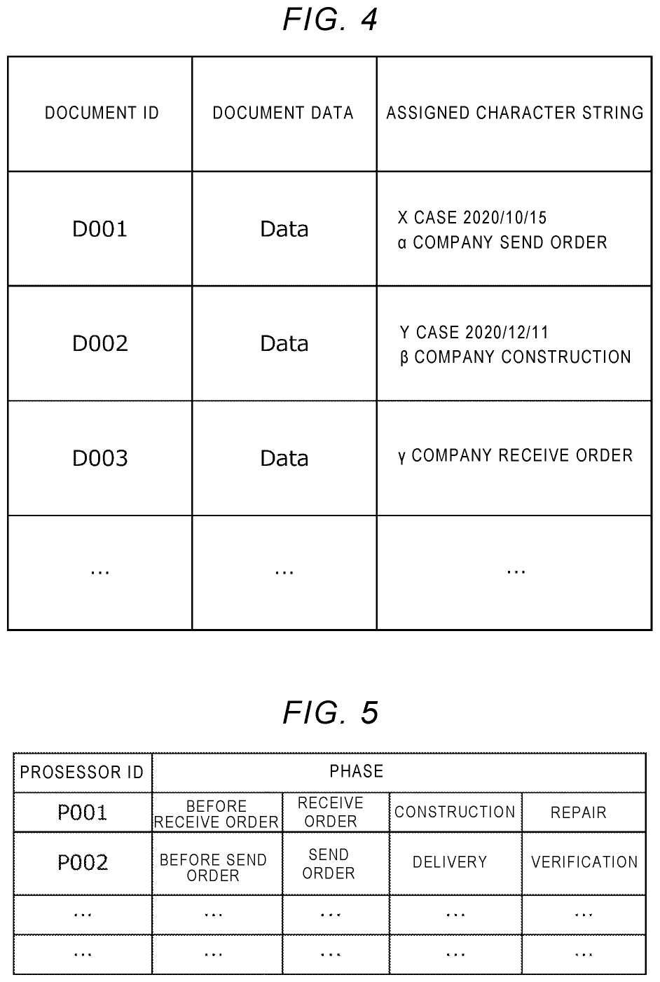

FIG. 4 is a diagram illustrating information related to document data stored in the document data storage apparatus 1. As shown in FIG. 4, the document data storage apparatus 1 stores a document ID for identifying document data, the document data, and an assigned character string assigned to the document data in association with each other. For example, document data having a document ID “D001” is associated with two assigned character strings of “X case 2020/10/15” and “α company send order”.

The information processing system 100 is used for plural tasks performed by a user. The plural tasks are performed in a time-series order, such as a task before an order for a product or a service is received, a task related to receiving of the order, a task related to construction, and a task related to repair. The document data storage apparatus 1 stores information on an order of such tasks.

FIG. 5 is a diagram illustrating information on the order of the tasks stored in the document data storage apparatus 1. In FIG. 5, a unit including a series of plural tasks is referred to as a “process”, and process IDs for identifying the tasks in units of the process are prepared. Stages of time-series tasks constituting each process are referred to as “phases”. For example, a process having a process ID “P001” includes four tasks performed in an order of “before receive order”, “receive order”, “construction”, and “repair”, and the stage of each task corresponds to one phase. For example, a process having a process ID “P002” includes four tasks performed in an order of “before send order”, “send order”, “delivery”, and “verification”, and the stage of each task corresponds to one phase.

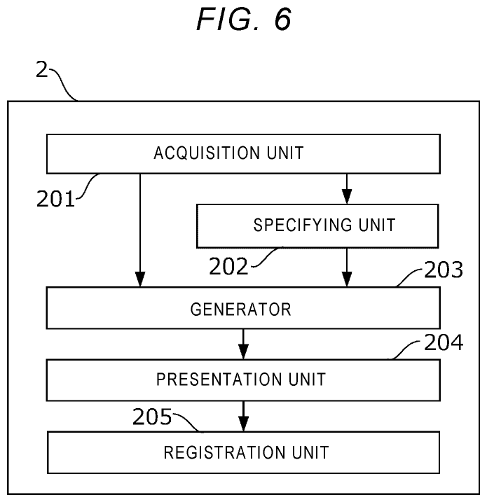

FIG. 6 is a block diagram illustrating a functional configuration of the information processing apparatus 2. The information processing apparatus 2 includes an acquisition unit 201, a specifying unit 202, a generator 203, a presentation unit 204, and a registration unit 205. The functions are implemented by the following manner. That is, predetermined software (program) is loaded into a hardware such as the processor 21 and the memory 22, and the processor 21 executes the loaded software to perform an arithmetic operation, to thereby control communication by the communication IF 24 and control at least one of reading data from or writing data into the memory 22 and the storage 23.

The acquisition unit 201 acquires, from the document data storage apparatus 1, a history of assigned character strings assigned to the document data by the user. The acquisition unit 201 also acquires information on an order of tasks from the document data storage apparatus 1.

The specifying unit 202 specifies a pattern to be followed when a character string is assigned to document data, using the acquired history of the assigned character strings. The specifying unit 202 also specifies a pattern to be followed when a character string is assigned to document data, using the acquired information on the order of the tasks.

The generator 203 generates a candidate character string to be assigned to document data of interest according to (i) a character string included in the document data of interest and (ii) the pattern which the specifying unit 202 has specified using the history of the assigned character strings. The term “candidate character string to be assigned to document data of interest” may be simply referred to as a “candidate character string. The generator 203 also generates a candidate character string to be assigned to the document data of interest according to the pattern which the specifying unit 202 has specified using the information on the order of the tasks.

The presentation unit 204 presents the candidate character strings generated by the generator 203 to the user by, for example, displaying the candidate character strings.

When the user designates one of the candidate character strings presented by the presentation unit 204, the registration unit 205 registers the designated candidate character string in the document data storage apparatus 1 in association with the document data of interest.

### [2] Operation

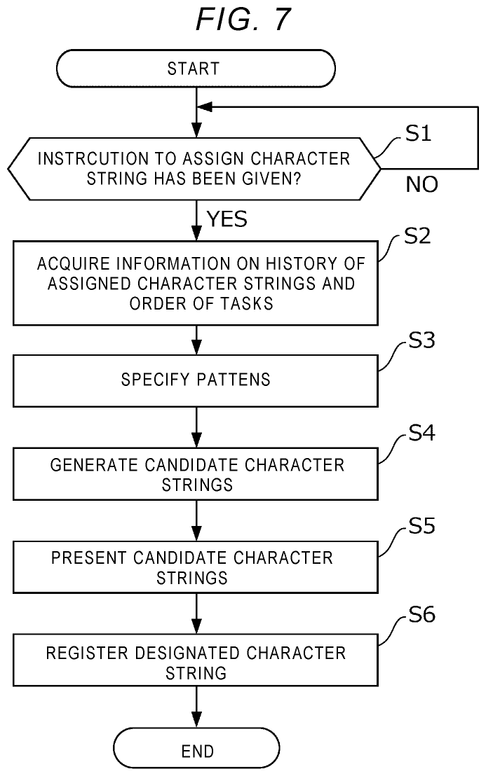

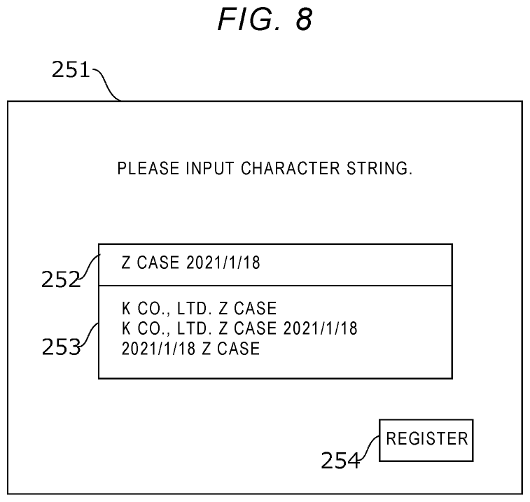

An operation of the information processing apparatus 2 will be described with reference to a flowchart of FIG. 7. In FIG. 7, when the user creates new document data on the information processing apparatus 2 and instructs to assign a character string to the document data (which is referred to as “document data of interest”; step S1: YES), the acquisition unit 201 acquires, from the document data storage apparatus 1, a history of assigned character strings that were assigned to all document data (step S2). The acquisition unit 201 acquires the information on an order of tasks from the document data storage apparatus 1 (step S2).

Next, the specifying unit 202 specifies a pattern in the assigned character strings assigned to the document data using the acquired history of the assigned character strings (step S3). For example, in the example of FIG. 4, the specifying unit 202 rearranges the assigned character strings in the acquired history based on a predetermined criterion and compares the assigned character strings with each other, thereby specifying a pattern that an assigned character string following an assigned character string of “O case” (where O is any character string) is numbers indicating a date. The specifying unit 202 also specifies a pattern in the assigned character strings assigned to the document data using the acquired information on the order of tasks. For example, in the examples of FIGS. 4 and 5, the specifying unit 202 specifies a pattern that an assigned character string following an assigned character string of “O company” is a character string corresponding to a phase of a task. The specifying unit 202 specifies a pattern by at least one of the two pattern specifying methods described above, which is capable of specifying the pattern.

Next, when the pattern has been specified using the history of the assigned character strings, the generator 203 determine whether a character string included in the document data of interest matches the pattern, and if the character string included in the document data of interest matches the pattern, the generator 203 generates a candidate character string to be assigned to the document data of interest according to (i) the character string included in the document data of interest and (ii) the pattern (step S4). For example, it is assumed that the document data of interest includes a character string of “Z case”. Because of the pattern that an assigned character string following an assigned character string of “O case” (where O is any character string) is numbers indicating a date, the generator 203 generates a candidate character string of “Z case 2021/1/18” in which a character string indicating the present date and time (for example, 2021/1/18) is placed after the character string of “Z case”. In determining whether a character string included in the document data of interest matches the pattern, the generator 203 may use, as a character string included in the document data of interest, a character string located at a predetermined position in the document data of interest such as a file name of the document data of interest or a title of the document. It is noted that the specifying unit 202 may specify plural patterns. Thus, the generator 203 may generate plural candidate character strings. For example, it is assumed that the document data of interest includes a character string of “Z case” and the specifying unit 202 has specified (i) a pattern that an assigned character string following an assigned character string of “O case” (where O is any character string) is numbers indicating a date and (ii) a pattern that an assigned character string following the assigned character string of “O case” is a character string indicating a company name included in the document data of interest, the generator 203 generates a candidate character string of “Z case 2021/1/18” and a candidate character string of “K Co., Ltd. Z case” in which a character string (for example, “K Co., Ltd.”) indicating the company name included in the document data of interest is placed before the character string of “Z case”.

Next, when the pattern has been specified using the information on the order of tasks, the generator 203 determine whether a character string included in the document data of interest matches the pattern, and if the character string included in the document data of interest matches the pattern, the generator 203 generates a candidate character string to be assigned to the document data of interest according to (i) the character string included in the document data of interest and (ii) the pattern (step S4). For example, it is assumed that the document data of interest includes a character string of “γ company”. Because of the pattern that an assigned character string following an assigned character string of “company O” (where “O” is any character string) is a character string indicating a phase of a task, the generator 203 searches a task phase management system (not shown) to specify a task phase related to “γ company”, and generates a candidate character string of “γ company receive order” in which a character string (for example, “receive order”) indicating a specified task phase is placed after a character string of “γ company”. In determining whether a character string included in the document data of interest matches the pattern, the generator 203 may use, as a character string included in the document data of interest, a character string located at a predetermined position in the document data of interest such as a file name of the document data of interest or a title of the document. It is noted that the specifying unit 202 may specify plural patterns. Thus, the generator 203 may generate plural candidate character strings. For example, it is assumed that the document data of interest includes the character string of “γ company” and that the specifying unit 202 has specified the pattern that an assigned character string following an assigned character string of “O company” (where O is any character string) is numbers indicating a date and (ii) a pattern that (a) an assigned character string preceding an assigned character string of “company O” is a character string indicating the current date and time and (b) an assigned character string following the assigned character string of “O company” is a character string indicating a phase of a task. In this case, the generator 203 generates the candidate character string of “γ company receive order” and a candidate character string “2021/1/18 γ company receive order” in which a character string indicating the current date and time is placed before “γ company”.

Next, the presentation unit 204 presents the candidate character strings generated by the generator 203 to the user (step S5). Specifically, the presentation unit 204 displays the candidate character strings generated by the generator 203 in an input field for inputting a character string in a pull-down manner, for example, on the display device of the UI unit 25 of the information processing apparatus 2. At this time, when the patterns have been respectively specified by the two pattern specifying methods and the candidate character strings have been generated for the respective patterns, the presentation unit 204 may present all candidate character strings or may present the candidate character string based on one of the two pattern specifying methods.

Here, FIG. 8 is a diagram showing an example of a screen displayed on the display device of the UI unit 25 of the information processing apparatus 2. On a screen 251, an input field 252 for inputting a character string, a pull-down field 253 arranged below the input field 252, and a register button 254 for registering a character string are di splayed. In this example, four candidate character strings of “Z case 2021/1/18”, “K Co., Ltd. Z case”, “K Co., Ltd. Z case 2021/1/18”, and “2021/1/18 Z case” are presented as the candidate character strings generated by the generator 203. That is, here, the specifying unit 202 has specified four patterns. The user selects any candidate character string from the candidate character strings and taps (or presses) the register button 254, to thereby designate the selected candidate character string. Furthermore, the user may correct and input a part of the candidate character string presented by the presentation unit 204, or may input a character string that is not included in the candidate character strings presented by the presentation unit 204.

Then, when one of the candidate character strings presented by the presentation unit 204 is designated by the user, the registration unit 205 registers the designated character string in the document data storage apparatus 1 in association with the document data of interest (step S6). At this time, when one of the candidate character strings presented by the presentation unit 204 is designated by the user, the registration unit 205 registers the designated character string in the document data storage apparatus 1 in association with the document data of interest. Furthermore, when the user designates another character string, the registration unit 205 may register the other character string in the document data storage apparatus 1 in association with the document data of interest. That is, the user may assign plural character strings to the document data. Then, when the user inputs a correction to a part of the candidate character strings presented by the presentation unit 204, or when the user inputs a character string that is not included in the candidate character strings presented by the presentation unit 204, the registration unit 205 registers the input character string in the document data storage apparatus 1 in association with the document data of interest.

According to the exemplary embodiment described above, a candidate character string to be assigned to a new document can be generated using a history of character strings assigned to document data by a user or information on an order of tasks.

### [3] Modification

The above described exemplary embodiment is merely an example of carrying out the present disclosure, and may be modified as follows. The above described exemplary embodiment and the modifications described below may be combined and implemented as necessary.

(1) When a degree of similarity between (i) a generated candidate character string to be assigned to document data of interest and (ii) a character string already assigned to the document data of interest is equal to or greater than a threshold value, the processor 21 may not present the candidate character string. For example, it is assumed that a character string which has been assigned to certain document data in response to an input by a user or the like is “C company_send order” and that a newly generated candidate character string to be assigned to the document data is “C company_send order”. A degree of similarity between these character strings is equal to or greater than the threshold value (for example, 90%), and the character strings have substantially the same meaning. In such a case, the processor 21 does not present a candidate character string of “C company_send order”.
(2) When presenting a newly generated candidate character string, the processor 21 may display, together with the newly generated candidate character string, a character string which has been assigned to existing document data and which is similar to the newly generated candidate character string. In this case, together with the newly generated candidate character string, the processor 21 may present a character string assigned to the existing document data in an identifiable manner. For example, it is assumed that the character string assigned to the existing document data is “C company_before send order” and that a generated candidate character string to be assigned to certain document data is “C company_receive order”. In this case, “C company_before send order/existing” may be presented as the character string assigned to the existing document data, and “C company_receive order/new” may be presented as the generated candidate character string. As a result, the user can know a difference between the newly generated candidate character string and the character string which has been assigned to the existing document data and which is similar to the newly generated candidate character string.
(3) As described above, when presenting a newly generated candidate character string, the processor 21 may display, together with the newly generated candidate character string, a character string which has been assigned to existing document data and which is similar to the newly generated candidate character string. At this time, the processor 21 may display (i) the number of pieces of document data to which the same character string as the newly generated candidate character string has been assigned and (ii) the number of pieces of document data to which a character string(s) similar to the newly generated candidate character string were assigned. As a result, the user can know a difference between (i) the number of documents to which newly generated candidate character string has been assigned and (ii) the number of pieces of document data to which a character string(s) similar to the newly generated candidate character string were assigned.
(4) The processor 21 may specify a pattern based on a combination of information on an order of tasks and information other than information on the tasks. Examples of the information other than the information on the tasks include information input by a user in association with document data (for example, a name of a case to which the document data is related), information on an organization to which the user belongs (for example, a name of a department or a company to which the user belongs). The processor 21 may acquire information other than the information on the tasks from, for example, information input to the information processing apparatus 2 or an external device, and may generate a candidate character string based on a combination of the acquired information and the information on the order of the tasks.
(5) The information on the document data illustrated in FIG. 4 and the information on the order of the tasks illustrated in FIG. 5 may be stored in different apparatuses, or both information may be stored in the information processing apparatus 2.

In the above-described exemplary embodiment, the program executed by the processor 21 of the information processing apparatus 2 or the processor 11 of the document data storage apparatus 1 may be downloaded via a communication line such as the Internet. The programs may be provided in a state of being recorded in a computer readable recording medium such as a magnetic recording medium (a magnetic tape, a magnetic disk, or the like), an optical recording medium (an optical disc or the like), a magneto-optical recording medium, or a semiconductor memory.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
acquire a history of character strings assigned to document data by a user;
specify a pattern in the character strings assigned to the document data using the history of the character strings; and
generate a candidate character string to be assigned to document data of interest according to a character string included in the document data of interest and the specified pattern.

2. An information processing apparatus comprising:
a processor configured to:
acquire information on an order of tasks;
specify a pattern in character strings assigned to document data using the information on the order of the tasks; and
generate a candidate character string to be assigned to document data of interest according to the specified pattern.

3. The information processing apparatus according to claim 1, wherein
the processor is configured to:
present the generated candidate character string; and
when the presented candidate character string is designated, register the designated candidate character string in association with the document data of interest.

4. The information processing apparatus according to claim 2, wherein
the processor is configured to:
present the generated candidate character string; and
when the presented candidate character string is designated, register the designated candidate character string in association with the document data of interest.

5. The information processing apparatus according to claim 1, wherein
the processor is configured to, when a degree of similarity between (i) the generated candidate character string and (ii) a character string already assigned to the document data of interest is equal to or greater than a threshold value, not present the candidate character string.

6. The information processing apparatus according to claim 2, wherein
the processor is configured to, when a degree of similarity between (i) the generated candidate character string and (ii) a character string already assigned to the document data of interest is equal to or greater than a threshold value, not present the candidate character string.

7. The information processing apparatus according to claim 1, wherein
the processor is configured to present a newly generated candidate character string and a character string assigned to existing document data in an identifiable manner.

8. The information processing apparatus according to claim 2, wherein
the processor is configured to present a newly generated candidate character string and a character string assigned to existing document data in an identifiable manner.

9. The information processing apparatus according to claim 3, wherein
the processor is configured to present information on an amount of document data registered in association with a character string.

10. The information processing apparatus according to claim 4, wherein
the processor is configured to present information on an amount of document data registered in association with a character string.

11. The information processing apparatus according to claim 2, wherein
the processor is configured to specify the pattern based on a combination of the information on the order of the tasks and information other than information on the tasks.

12. A non-transitory computer readable medium storing a program that causes a computer to execute information processing, the information processing comprising:
acquiring a history of character strings assigned to document data by a user;
specifying a pattern in the character strings assigned to the document data using the history of the character strings; and
generating a candidate character string to be assigned to document data of interest according to a character string included in the document data of interest and the specified pattern.

13. A non-transitory computer readable medium storing a program that causes a computer to execute information processing, the information processing comprising:
acquiring information on an order of tasks;
specifying a pattern in character strings assigned to document data using the information on the order of the tasks; and
generating a candidate character string to be assigned to document data of interest according to the specified pattern.
